(19) United States
(12) Patent Application Publication
(10) Pub. No.: US 2026/0124632 A1
(43) Pub. Date: May 7, 2026

(54) Machine and method for manufacturing closures, closure and pattern roller

(71) Applicant: Silgan Holdings Inc., Norwalk, CT (US)

(72) Inventors: Tomasz Adam Gorczyca, Niepolomice (PL); Tomasz Sylwester Flis, Niepolomice (PL); Franz Otto Holger Reissig, Sehnde (DE)

(73) Assignee: Silgan Holdings Inc., Norwalk, CT (US)

(21) Appl. No.: 19/377,343

(22) Filed: Nov. 3, 2025

(30) Foreign Application Priority Data
Nov. 6, 2024 (EP) 24211164.9

(51) Int. Cl. B05C 1/02; B65D 65/42

(52) U.S. Cl. CPC B05C 1/025; B65D 65/42

(57) ABSTRACT

The present disclosure relates to a machine for manufacturing closures. The machine comprises a conveyor device configured to provide a metal sheet; at least one storage storing a coating; at least one pattern roller, wherein the pattern roller comprises a plurality of first areas and at least one second area, wherein the first areas are configured to take up the coating from the storage; and at least one transfer roller. The pattern roller is configured to transfer the coating in the first areas to the transfer roller and the transfer roller is configured to transfer the coating to the metal sheet such that the metal sheet is provided with the coating in areas corresponding to the first areas of the pattern roller.

### FIELD OF THE DISCLOSURE

The present disclosure relates to a machine for manufacturing closures, a method for manufacturing closures, a closure and a pattern roller for transferring coating to a transfer roller.

### BACKGROUND OF THE DISCLOSURE

Metal closures for bottles or jars are usually made from a metal sheet. A portion of the metal sheet is cut out, for example by stamping, and the closure is formed from the cut-out portion of the metal sheet by known techniques. A portion of the closure comes into contact with the filling of the bottle or jar when the closure is applied to the filled bottle or jar. Often, the filling is foodstuff. To prevent or reduce corrosion of the metallic portion of the closure one to three layers of coating are applied to the inner surface of the closure.

However, thick coating layers cause problems during the closure manufacturing process, mainly during the cutting process. For example, leftovers of coating created during the cutting process on the cutting machine (for example on the press) called “hairs” are a problem. These leftovers are contaminating not only the machine but also the closures and consequently create defective closures (visually or mechanically defective closures).

### SUMMARY OF THE DISCLOSURE

It is an object of the present disclosure to reduce the number of defective closures during manufacturing of the closures. It is another object of the present disclosure to reduce coating consumption during manufacturing of closures. It is another object of the present disclosure to improve recyclability of waste material produced during manufacturing of closures.

One or more of the above objects are solved by the combination of features of the independent claims. Advantageous embodiments are provided in the respective dependent claims and the description. Features of an independent claim may be combined with features of one or more claims dependent on the independent claim, and features of one or more dependent claims can be combined with each other. Also, features of independent claims may be combined.

According to an aspect of the present disclosure, a machine is presented. The machine may be a machine for manufacturing closures. The machine may comprise a conveyor device configured to provide a metal sheet. The machine may comprise at least one storage for storing or storing a coating. The machine may comprise at least one pattern roller. The pattern roller may comprise a plurality of first areas. The pattern roller may comprise at least one second area. The first areas may be configured to take up or to absorb or to pick up the coating from the storage. The machine may comprise at least one transfer roller. The pattern roller may be configured to transfer the coating in the first areas to the transfer roller. The transfer roller may be configured to transfer the coating to the metal sheet such that the metal sheet is provided with the coating in areas corresponding to the first areas of the pattern roller.

According to an aspect of the present disclosure, a method is presented. The method may be a method for manufacturing closures. The method may comprise the step of providing a metal sheet. The method may comprise the step of transferring a coating from a plurality of first areas of a pattern roller to a transfer roller. The method may comprise the step of transferring the coating from the transfer roller to the metal sheet such that the metal sheet is provided with the coating in areas corresponding to the first areas of the pattern roller.

Any one of the herein disclosed methods may be performed by any one of the herein disclosed machines. Any one of the herein disclosed machines may be used in any one of the herein disclosed methods.

According to an aspect of the present disclosure, a closure is presented. The closure may comprise a metal support. The closure may comprise at least one coating. The coating may not cover the entire metal support.

Any one of the herein disclosed closures may be manufactured by any one of the herein disclosed machines. Any one of the herein disclosed closures may be manufactured by any one of the herein disclosed methods.

According to an aspect of the present disclosure, a pattern roller is presented. The pattern roller may be a pattern roller for transferring coating to a transfer roller. The pattern roller may comprise a plurality of first areas. The first areas may be configured to take up the coating from a storage. The pattern roller may comprise at least one second area. The second area may be configured to take up the coating from the storage. The transfer volume and/or the transfer weight per unit surface area of the second area may be smaller than of the first areas. In other words, the transfer volume and/or the transfer weight (per unit surface area) of the first areas may be larger than the transfer volume and/or transfer weight (per unit surface area) of the second area.

If both, the first areas and the second area, are configured to take up coating and transfer the coating to the transfer roller which transfers the coating to the metal sheet, the metal sheet may be coated in one run, and different areas of the metal sheet may be coated with different amounts of coating.

The storage may be any herein disclosed storage for storing a coating. The pattern roller may be any herein disclosed pattern roller. Any herein disclosed machine and/or method may use the pattern roller.

The pattern roller may not (directly) come into contact with the metal sheet that is supposed to be coated. According to the disclosure, the shape, size and/or amount of the coating may be defined by the pattern roller. The coating on the pattern roller may be transferred to a transfer roller. The transfer roller may come into contact with the metal sheet to apply the coating to the metal sheet.

In general, the closure (also called “cap” or “vessel closure”) may be a screw closure. The closure may be a metal closure. The closure may comprise a metal support. The metal support may consist of metal. The closure may comprise a sealing element. The sealing element may comprise polyvinyl chloride (PVC) or at least one thermoplastic elastomer, preferably at least one olefinic thermoplastic elastomer.

The closure may be a lug closure. The closure may have at least 3 lugs, preferably at least 4 lugs, preferably at least 6 lugs. The closure may have from 3 to 6 lugs.

The closure may be a press-on twist-off closure (PT-closure). In the case of PT-closures, a considerable proportion of the sealing element can also be formed in the skirt region of the closure. During the closing of a container, a PT-closure is pressed onto the container mouth (“press-on”) while the sealing element is in the heated state and sufficiently flowable. An outer threading in the mouth region of the container produces an inner threading (as negative of the outer threading) in the sealing element region on the skirt of the closure. The PT-closure is removed from the container by a twisting movement (“twist-off”).

The closure may close or seal a container. The container may comprise a container mouth and a closable opening at the end of the container mouth. The opening may be closed by the closure. The container can be a glass container, a plastic container or a metal container. In particular, the container is a glass container.

The conveyor device may include a conveyor belt or may be a conveyor belt. The conveyor device may include a feeding table. On the feeding table, a plurality of metal sheets may be stored. Metal sheets may be transported to the transfer roller, preferably from the feeding table. After the metal sheets have passed the transfer roller, the metal sheets may be transported by the conveyor device to another portion of the conveyor device, for example, for curing or drying of the coating.

The storage storing the coating may comprise at least one chamber. The coating may be stored in the chamber. The storage may comprise at least one inlet connected to a coating supply, for example to a tank. Coating may be supplied to the storage from the supply.

One side of the storage may comprise an opening. Via the opening, the pattern roller may come in contact with the coating. For example, when the pattern roller rotates, a portion of the surface (including the first areas and the second area) may come in contact with the coating via the opening of the storage.

The storage may comprise or may be a chambered doctor blade system. The storage may comprise end seals and/or doctor blades. One of the blades may act as a retaining blade, preferably holding the coating within the storage. The other one of the blades may remove excess coating from the surface of the pattern roller.

The coating may be a liquid substance. The coating may be a varnish or a lacquer, preferably a pigmented lacquer.

The pattern roller may have a diameter between 50 mm and 750 mm, preferably between 100 mm and 500 mm, preferably between 200 mm and 400 mm, preferably between 300 mm and 350 mm.

The pattern roller may have a substantially cylindrical shape.

The pattern roller may comprise at least 5, preferably at least 10, preferably at least 20, preferably at least 30, preferably at least 50, first areas. The first areas may be separated from each other, for example by the second area.

When the pattern roller rotates, the first areas and the second area may come into contact with the coating stored in the storage. When the pattern roller rotates further, the first areas and the second area may pass a seal or a blade of the storage and coating may not be transferred or may be removed from the second area. After a portion of the pattern roller has passed the storage (and the portion of the pattern roller is not in contact with the coating anymore), only the first areas may include coating. In other words, after the portion of the pattern roller has passed the storage (and the portion of the pattern roller is not in contact with the coating anymore), the second area may not include coating. Thereby, when the pattern roller rotates, the first areas of the pattern roller may take up or absorb or pick up coating from the storage. Also, the first areas and the second area may take up or absorb or pick up coating from the storage. When the pattern roller rotates, excess coating may be removed from the first areas and the second area by the seal or blade of the storage. Coating in the first areas and the second area may be transferred to the transfer roller. The transfer roller may transfer coating corresponding to the first areas and the second area to the metal sheet.

The pattern roller may be in contact with the transfer roller. The pattern roller and the transfer roller may rotate at substantially the same speed, preferably at substantially the same angular speed.

The pattern roller is configured to transfer the coating in the first areas to the transfer roller. Preferably, the pattern roller is configured to transfer the coating only in the first areas to the transfer roller. The second area of the pattern roller may not transfer coating to the transfer roller. When coating from the first areas of the pattern roller is transferred to the transfer roller, the transfer roller comprises coating in areas that correspond to the first areas of the pattern roller. However, it is also possible that the second area takes up coating from the storage and coating in the second area is transferred to the transfer roller.

The transfer roller may be in contact with the metal sheet. The metal sheet may travel at a speed that corresponds to the rotational speed of the transfer roller. Specifically, the circumferential speed of the transfer roller may be substantially equal to the travel speed of the metal sheet. The metal sheet may travel in a longitudinal direction. The transfer roller may be configured rotate. The metal sheet may be moved by the conveyor device or (at least partially) by the transfer roller.

The transfer roller is configured to transfer the coating (that was previously transferred to the transfer roller from the pattern roller) to the metal sheet. Since the shape and amount of coating on the transfer roller corresponds to shape and amount of coating in the first areas of the pattern roller, the shape and amount of coating on the metal sheet corresponds to shape and amount of coating in first areas of the pattern roller.

The first areas on the pattern roller may define the areas on the metal sheet that will be provided with coating. Closure blanks can be cut out or stamped out from the metal sheet. Typically, (exactly) one area in which coating is present on the metal sheet will be present in each of the closure blanks. The closure blank can be formed into a closure by known techniques and can be provided with a sealing element. Thereby, a closure may be manufactured.

Preferably, the resulting closure is at least coated in areas that come into contact with the filling (e.g., foodstuff) of a bottle or jar that is closed with the closure. However, it is preferred that not an entire surface of the closure is coated with the coating or different portions of the closure may be coated with different amounts of coating. Thereby, corrosion of the closure can be reduced or prevented, and coating material can be saved. Further, the number of defective closures is reduced because the cutting edge of the closure blanks does typically not cross or overlay with the coating or only with areas that are coated with a reduced amount of coating. The coated area of the metal sheet is typically smaller than the size of the closure blank cut out from the metal sheet. Also, recycling of scrap material of the metal sheet is improved because the scrap material is not coated with the coating or coated with a reduced amount of coating.

The first areas may be understood as first portions of a surface, e.g., of an outer surface of the pattern roller. The second area may be understood as a second portion of the surface, e.g., of the outer surface of the pattern roller.

Each of the first areas of the pattern roller may comprise a plurality of dimples. The first areas may be engraved into the surface of the pattern roller. The first areas may be engraved by mechanical engraving or laser engraving.

Each of the first areas may comprise a plurality of cells. The cells may be dimples (also called depressions). Each of the cells or dimples may have a diameter of between 50 μm and 500 μm, preferably between between 50 μm and 250 μm, preferably between 75 μm and 150 μm.

Each of the first areas may have a transfer volume of coating between 0.00010cm³ /cm² and 0.00800cm³ /cm², preferably between 0.00040cm³ /cm² and 0.00600cm³ /cm², preferably between 0.00072cm³ /cm² and 0.00380cm³ /cm². The transfer volume may be the volume of coating that will be transferred per unit surface area of the metal sheet.

Each of the first areas may have a transfer weight between 0.00010 g/cm² and 0.00800g/cm² , preferably between 0.00040 g/cm² and 0.00600g/cm² , preferably between 0.00075 g/cm² and 0.00400g/cm² . The transfer weight may be the weight of coating that will be transferred per unit surface area of metal sheet.

The surface of the second area of the pattern roller may be smooth. Specifically, the surface roughness of the second area is at most 50%, preferably at most 40%, preferably at most 30%, preferably at most 20%, preferably at most 10%, preferably at most 5%, of the surface roughness of at least one or of each of the first areas. The surface roughness may be an average or arithmetic average of profile height deviations from the mean line known in the art as Ra.

Dimples or cells in the first areas may be dimples or cells compared to the surface of the second area. Dimples or cells may be evenly distributed within the each of the first areas.

The second area may be configured to take up the coating from the storage. The pattern roller may be configured to transfer the coating in the first areas and in the second area to the transfer roller. The transfer roller may be configured to transfer the coating to the metal sheet such that the metal sheet is provided with the coating in areas corresponding to the first areas and the second area of the pattern roller. As mentioned above, since the first areas and the second area of the pattern roller take up coating that is transferred to the metal sheet, the metal sheet may be coated in one run.

The second area may comprise a plurality of dimples. The second area may be engraved into the surface of the pattern roller. The second area may be engraved by mechanical engraving or laser engraving. The second area may comprise a plurality of cells. The cells may be the dimples (also called depressions).

The transfer volume and/or transfer weight per unit surface area of the second area may be smaller than (the transfer volume and/or transfer weight) of the first areas.

Preferably, the transfer volume and/or the transfer weight (per unit surface area) of the second area is at most 95%, preferably at most 90%, preferably at most 80%, preferably at most 70%, preferably at most 60%, of the transfer volume and/or transfer weight (per unit surface area) of the first areas.

Preferably, the transfer volume and/or the transfer weight (per unit surface area) of the second area is at least 10 %, preferably at least 20 %, preferably at least 30 %, preferably at least 40 %, preferably at least 50 %, of the transfer volume and/or transfer weight (per unit surface area) of the first areas.

Preferably, the transfer volume and/or the transfer weight (per unit surface area) of the second area is between 10% and 95%, preferably between 20% and 90%, preferably between 30% and 80%, preferably between 40% and 70%, preferably between 50% and 60%, of the transfer volume and/or transfer weight (per unit surface area) of the first areas.

It is possible that the transfer volume and/or the transfer weight (per unit surface area) of the second area is at most 10%, preferably at most 5%, preferably at most 1%, preferably substantially 0%, of the transfer volume and/or transfer weight (per unit surface area) of the first areas. In this case the second area will transfer no or only a small amount of coating to the transfer roller.

Each of the first areas of the pattern roller may have a substantially circul ar area or shape. Areas of the metal sheet which are provided with the coating may have a substantially circular area or shape.

The second area of the pattern roller may surround the first areas of the pattern roller. The pattern roller may comprise (exactly or at most) one second area. The second area may not comprise dimples or cells. Also, the second area may comprise dimples or cells. The second area may at least extend between two adjacent first areas.

Each of the first areas of the pattern roller may have a diameter between 10 mm and 250 mm, preferably between 20 mm and 200 mm, preferably between 30 mm and 150 mm, preferably between 35 mm and 135 mm.

Each of the first areas of the pattern roller may have an area between 250 mm² and 30000mm² , preferably between 500 mm² and 25000mm² , preferably between 750 mm² and 20000mm² , preferably between 1000 mm² and 14000mm^{2 .}

The first areas of the pattern roller may be arranged in a grid on the pattern roller. The first areas of the pattern roller may be uniformly or evenly arranged on the pattern roller.

The diameter of the pattern roller may be substantially equal to the diameter of the transfer roller. The transfer roller may have a diameter between 100 mm and 500 mm, preferably between 200 mm and 400 mm, preferably between 300 mm and 350 mm, preferably between 320 mm and 350 mm.

The circumference of the pattern roller may be substantially equal to the length of the metal sheet. The circumference of the transfer roller may be substantially equal to the length of the metal sheet. The circumference of a roller may be determined in a plane that is perpendicular to the rotational axis of the roller. The length of the metal sheet may be the extension of the metal sheet in its travel direction on the conveyor device, in particular when passing the transfer roller.

The circumference of the pattern roller may be between 70% and 130%, preferably between 75% and 125%, preferably between 80% and 120%, preferably between 85% and 115%, preferably between 90% and 110%, preferably between 95% and 105%, of the length of the metal sheet.

The circumference of the pattern roller may be at least 100%, preferably at least 105%, preferably at least 110%, preferably at least 120%, of the length of the metal sheet

The pattern roller may comprise a steel core. The steel core may be covered by a layer comprising chromium.

The pattern roller may comprise a steel core. The steel core may be covered by a layer comprising copper. The copper layer may be covered by a layer comprising chromium. For example, first areas and/or the second area may be formed (e.g., engraved) in the copper layer. The copper layer may be covered by a chromium layer to protect the surface of the pattern roller. The chromium layer may be made by galvanization.

The pattern roller may comprise a steel core. The steel core may be covered by a ceramic (material). The first areas and/or the second area may be formed (e.g., engraved) in the ceramic layer.

The surface of the pattern roller may comprise or may be made of any material which has sufficient hardness to transfer coating to the transfer roller.

The hardness of the (surface of the) pattern roller may be higher than the hardness of the (surface of the) transfer roller. Preferably, the hardness of the (surface of the) pattern roller is at least 25%, preferably at least 50 %, preferably at least 75 %, preferably at least 100 %, higher than the hardness of the (surface of the) transfer roller.

The coating film weight may be defined by the capacity for coating of the first areas and/or the second area. For example, the amount of coating that can be taken up by each of the first areas and/or the second area may define the thickness or height of the coated areas on the metal sheet.

The pattern of the first areas and/or the second area on the pattern roller may define the pattern of coated areas on the metal sheet. The size and shape of the first areas and/or the second area on the pattern roller may define the size and shape of the coated areas on the metal sheet. Preferably, at least the area of the manufactured closure that will come into contact with the filling of the bottle or jar that is closed by the closure is provided with the coating. However, preferably, the coating is not applied to an entire surface of the closure but the coating may be applied to the entire surface of the closure.

The machine may be configured to apply at least two layers of coating to the metal sheet. Preferably, the machine is configured to apply at least three layers of coating to the metal sheet. The machine may also be configured to apply at most one layer of coating to the metal sheet.

The first layer may be applied to the metal sheet, e.g., in the above-described manner. A second layer may be applied to the coated metal sheet (coated with the first layer). The second layer may cover the first layer at least partially or completely. The first and second layers may only partially cover the metal sheet. A third layer may be applied to the coated metal sheet (coated with the first and second layers). The third layer may at least partially or completely cover the first layer and/or the second layer. The third layer may cover the entire metal sheet.

The layers of coating may overlap each other. At least one of the layers of coating covers substantially the entire metal sheet. Alternatively or additionally, at least one of the layers of coating only partially covers the metal sheet.

Each of the first areas may comprise a first subarea and a second subarea. The first subarea may be configured to take up a different amount of coating per area than the second subarea per area. For example, the first subarea and the second subarea may differ in their transfer weight and/or transfer volume for the coating.

Dimples or cells in the first subarea and the second subarea may differ. Thereby, a different amount of coating may be taken up by the first subarea and the second subarea. By providing the first subarea and the second subarea on the pattern roller, different thicknesses of coating may be provided on the metal sheet in one step of applying the coating.

The first subarea may have a substantially circular area or shape. The second subarea may surround the first subarea. When first subareas and second subareas are present, no second area may be present. In other words, the entire surface of the metal sheet may be coated but with different film thicknesses.

The first subareas may be equal to the herein described first areas and the second subareas may be equal to the herein described second area. The first subareas of the pattern roller may correspond to areas on the metal sheet that will come into contact with the filling when a closure is formed from portions of the metal sheet. The second subareas of the pattern roller may correspond to areas on the metal sheet that will not come into contact with the filling when a closure is formed from portions of the metal sheet. However, portions of the metal sheet corresponding to the second subareas of the pattern roller may still be part of the formed closure.

The machine may comprise a counter roller. The counter roller may also be called pressure roller. The metal sheet may be positioned between the transfer roller and the counter roller when the coating is transferred from the transfer roller to the metal sheet.

The metal sheet may be transported by the transfer roller and the counter roller. The transfer roller and the counter roller may contact the metal sheet and a rotation of the transfer roller and/or the counter roller may cause a movement of the metal sheet.

A force may be applied between the transfer roller and the counter roller, especially when the metal sheet is positioned between the transfer roller and the counter roller.

The diameter of the counter roller may be substantially equal to the diameter of the transfer roller and/or the pattern roller. The counter roller may have a diameter between 100 mm and 500 mm, preferably between 200 mm and 400 mm, preferably between 300 mm and 350 mm.

The counter roller may rotate at substantially the same speed as the transfer roller and/or the pattern roller.

The transfer roller may have a smooth outer surface. Specifically, the surface roughness of the outer surface of the transfer roller is at most 50%, preferably at most 40%, preferably at most 30%, preferably at most 20%, preferably at most 10%, preferably at most 5 %, of the surface roughness of at least one or of each of the first areas. The surface roughness may be an average or arithmetic average of profile height deviations from the mean line known in the art as Ra.

The Shore A hardness (determined according to ISO 7619-1, 23° C., 15 s holding time) of the outer surface of the transfer roller may be between 20 and 90, preferably between 30 and 80, preferably between 40 and 70, preferably between 50 and 60, preferably between 55 and 60.

The transfer roller, preferably the (outer) surface of the transfer roller, may comprises a plastic. The transfer roller, preferably the (outer) surface of the transfer roller, may comprise a rubber, a (thermoplastic) elastomer, a (olefinic) elastomer, and/or polyurethane.

The pattern roller may comprise at least one third area. The third area may be configured to transfer at least one marking to the metal sheet for verification of correct positioning of the coating areas on the metal sheet.

The third area may differ from the first areas and/or the second area. Preferably, the third area differs from the first areas and/or the second areas by at least one of surface roughness, size, shape, transfer volume, and transfer weight.

The third area may comprise dimples or cells, preferably similar to or equal to the dimples or cells as described with reference to the first areas above. The third area may be configured to take up or absorb or pick up coating or another liquid, preferably similar to or equal to as described with reference to the first areas above.

The third area may be positioned on the pattern roller such that at least one marking is transferred to the metal sheet. The coating or liquid may be taken up by the third area and transferred to the transfer roller. The transfer roller may transfer the coating or liquid to the metal sheet as a marking. Preferably, the marking on the metal sheet is positioned outside areas that cut out from the metal sheet to form closures. Specifically, the marking is positioned on the metal sheet in an edge region of the metal sheet. For example, the marking may be positioned in a corner of the metal sheet.

A (shortest) distance between a (closest) edge of the metal sheet and the marking on the metal sheet may be less than 200 mm, preferably less than 150 mm, preferably less than 100 mm, preferably less than 75 mm, preferably less than 50 mm, preferably less than 25 mm, preferably less than 10 mm, preferably less than 5 mm, preferably substantially 0 mm.

After the metal sheet is provided with the coating, the coating on the metal sheet may be dried or cured.

A closure may be formed from the coated sheet by techniques known in the art. For example, portions of the metal sheet may be cut out or stamped to receive a closure blank. The closure blank may be formed into a closure. The closure may be provided with a sealing element. The manufactured closure may be used to close or seal a filled bottle or jar.

The closure may include a metal support. The metal support may be the metallic portion of the closure. The coating may be applied to at least one surface of the metal support. The at least one surface may be an inner surface of the closure. The inner surface of the closure may be a surface that (at least partially) will come into contact with a filling of a bottle or a jar when the closure is applied to a filled bottle or jar.

At least the portion of the metal support that is supposed to come into contact with the filling may be (fully or entirely) covered by the coating. The coating may not cover the entire metal support. Alternatively, when the coating covers the entire metal support, the coating may not have a constant thickness over its entire extension.

The closure may comprise at least two different coatings. One of the coatings may be the coating that does not cover the entire metal support. The other one of the coatings may cover the entire metal support.

In general, the term “substantially” may allow a deviation of ±20%, ±15%, ±10%, ±5%, ±3%, or ±1%. The term “correspond” may mean that the shape, size, geometry, thickness, volume, and/or weight is equal or substantially equal.

### DESCRIPTION OF THE DRAWINGS

The above-mentioned attributes and other features and advantages of the present disclosure and the manner of attaining them will become more apparent and the present disclosure itself will be better understood by reference to the following description of embodiments of the present technique taken in conjunction with the accompanying drawings, wherein:

FIG. 1 shows a machine 100 in a perspective view;

FIG. 2 shows a machine 100 in a side view;

FIG. 3 shows a pattern roller 20;

FIG. 4 shows a coated metal sheet 50;

FIG. 5 shows a relation between a coated area 51 on a metal sheet 50 and a first area 11 on the pattern roller 20;

FIG. 6 shows different steps during application of coatings 51, 52, 53 to a metal sheet 50;

FIG. 7a shows a closure blank 55; and

FIG. 7b shows a closure 200.

Hereinafter, above-mentioned and other features of the present disclosure are described in detail. Various embodiments are described with reference to the drawings, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the disclosure. It may be evident that such embodiments may be practiced without these specific details.

It may be noted that terms like “first”, “second” and “third” are merely used to distinguishing elements, not to count elements. For example, when a “second” element is addressed, this does not imply that a “first” element must be present.

The steps described herein with reference to one or more machines may be employed by a method. Also, method steps described herein may be employed by any one of the herein described machines. For example, any one of the machines may include a controller that is configured to perform any one of the herein disclosed method steps.

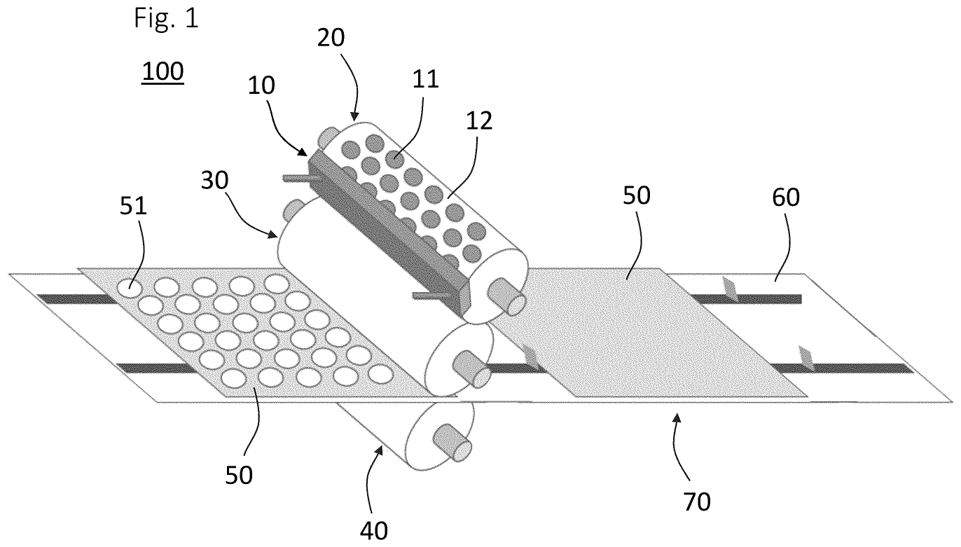

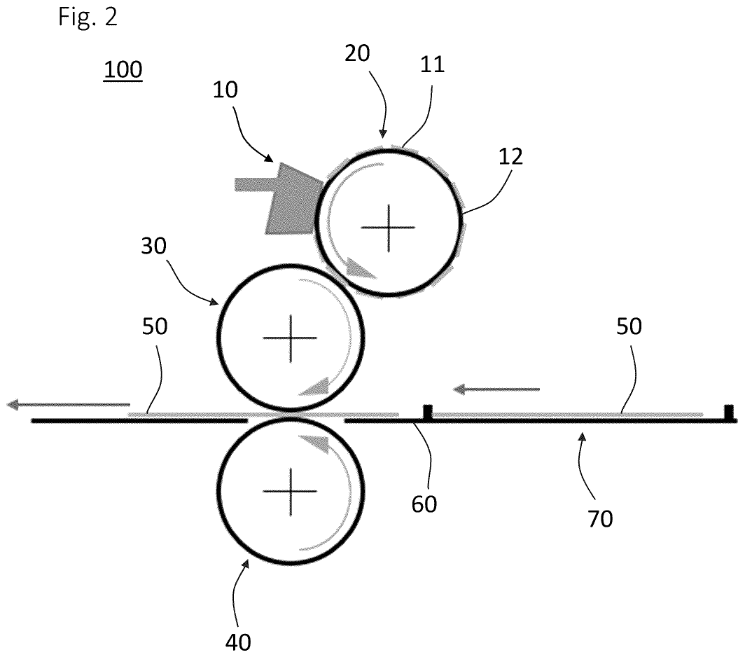

FIG. 1 schematically shows a machine 100 in a perspective view. FIG. 2 schematically shows a machine 100 in a side view. The machines 100 of FIG. 1 and FIG. 2 may be similar or same and will be described together in the following.

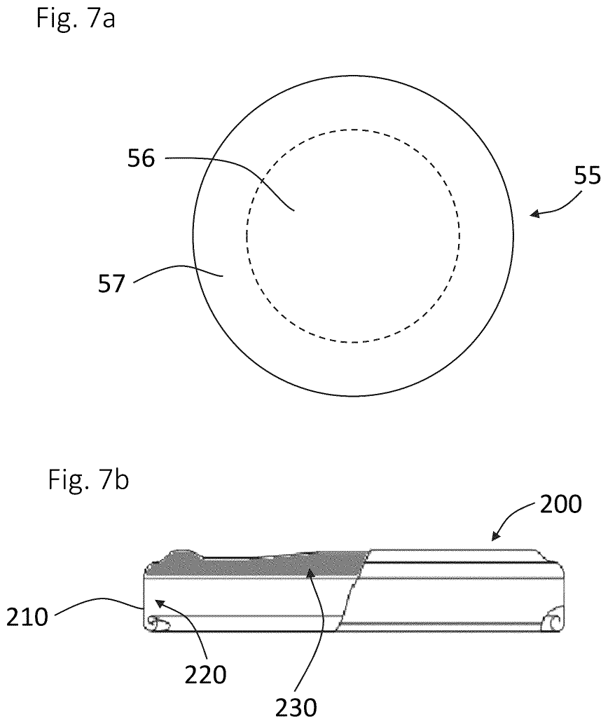

The machine 100 may be a machine for manufacturing a closure 200 (see FIG. 7b). Not all components necessary to manufacture a closure 200 are shown in FIGS. 1 and 2.

The machine 100 may comprise a storage 10 configured to store or storing a coating material (also referred to as coating). The coating may be liquid, e.g., a varnish or a lacquer. The storage 10 may comprise a chamber in which the coating is stored. The chamber may be substantially completely filled with coating. The chamber may include at least one supply channel for supplying coating to the chamber.

The machine 100 may comprise a pattern roller 20. The pattern roller 20 may be a substantially cylindrical roller that is configured to rotate about its rotational axis. The rotational axis may be the longitudinal axis of the pattern roller 20.

The pattern roller 20 may comprise an outer surface. A plurality of first areas 11 and at least one or at most one second area 12 may be present in the outer surface of the pattern roller 20.

The first areas 11 are configured to take up, absorb or pick up coating from the storage 10. The first areas 11 may be formed as dimples or cells. The dimples or cells may be engraved in the outer surface of the pattern roller 20. The first areas 11 may be uniformly or evenly formed in the pattern roller 20.

The second area 12 of the pattern roller 20 may be smooth or may have a smooth surface. Preferably, the second area 12 is substantially not configured to take up, absorb or pick up coating, specifically not in a relevant amount.

Also, the second area 12 of the pattern roller 20 may be configured to take up, absorb or pick up coating from the storage 10. The second area 12 may be formed as dimples or cells. The dimples or cells may be engraved in the outer surface of the pattern roller 20. The second area 12 may be uniformly or evenly formed in the pattern roller 20. The second area 12 may be configured to take up less coating (per unit surface area) than the first areas 11. Preferably, the transfer volume and/or transfer weight of the first areas 11 may be larger than the transfer volume and/or transfer weight of the second area 12.

When the pattern roller 20 rotates, a portion of the pattern roller 20 comes into contact with the coating. The storage 10 may have at least one opening that is sealed on its edges with respect to the pattern roller 20. The storage 10 may comprise seals or blades on opposite edges of the opening. The portion of the pattern roller 20 that comes into contact with the coating is wetted with the coating. This portion of the pattern roller 20 may include (portions of) first areas 11 and (a portion of) the second area 12.

When the pattern roller 20 rotates further, excess coating will be removed from the pattern roller 20 by one of the seals or blades of the storage 10. Coating may be substantially completely removed from the second area 12 and a defined amount of coating will remain in the first areas 11. It is possible that defined amounts of coating remain in the first areas 11 and the second area 12. Thereby, the pattern roller 20 is equipped with coating in the first areas 11 and/or the second area 12.

As mentioned above, the storage 10 may be a chambered doctor blade system.

The machine may comprise a transfer roller 30. The transfer roller 30 may have a smooth surface. The surface may include a plastic, for example, an elastomer. The transfer roller 30 may be a substantially cylindrical roller that is configured to rotate about its rotational axis. The rotational axis may be the longitudinal axis of the transfer roller 30. Specifically, the transfer roller 30 may rotate at substantially the same speed as the pattern roller 20. The pattern roller 20 and the transfer roller 30 may have substantially the same diameter.

A portion of the transfer roller 30 may contact a portion of the pattern roller 20. Preferably, the portion of the pattern roller 20 includes first areas 11 and/or the second area 12 that comprise coating. The coating from first areas 11 and/or the second area 12 of the pattern roller 20 may be transferred to the surface of the transfer roller 30. By rotating the pattern roller 20 and the transfer roller 30, coating may be taken up from the storage 10 in the first areas 11 and/or the second area 12 of the pattern roller 20 and transferred to the transfer roller 30.

The coating on the transfer roller 30 may substantially correspond to the coating in the first areas 11 and/or the second area 12 on the pattern roller 20. The shape, size, amount, and/or weight of coating in the first areas 11 and/or the second area 12 may be substantially equal to the coating on the transfer roller 30.

The machine 100 may comprise a conveyor device 60. The conveyor device 60 may be or include a conveyor belt. The conveyor device 60 may comprise a feeding table 70. Metal sheets 50 may be stored in the feeding table 70. Individual metal sheets 50 may be transported from the feeding table 70 towards the transfer roller 30.

The metal sheet 50 may come into contact with (a portion of) the transfer roller 30. Coating on the transfer roller 30 may be transferred to the metal sheet 50 as the metal sheet 50 passes the transfer roller 30. Thereby, the metal sheet 50 may be provided with coating.

Since coating in the first areas 11 and/or the second area 12 of the pattern roller 20 is transferred to the transfer roller 30 and the coating from the transfer roller 30 is transferred to the metal sheet 50, the coating on the metal sheet 50 corresponds to the first areas 11 and/or the second area 12 of the pattern roller 20. “Corresponding” may mean that the shape, size, geometry, thickness, volume, and/or weight is equal or substantially equal.

The machine 100 may comprise a counter roller 40. The counter roller 40 may have a smooth surface. The surface may include a plastic, for example, an elastomer. The counter roller 40 may comprise or consist of steel. Preferably, at least the surface of the counter roller 40 may be made of steel. The counter roller 40 may be a substantially cylindrical roller that is configured to rotate about its rotational axis. The rotational axis may be the longitudinal axis of the counter roller 40. Specifically, the counter roller 40 may rotate at substantially the same speed as the pattern roller 20 and/or the transfer roller 30. The counter roller 40 and at least one of the pattern roller 20 and the transfer roller 30 may have substantially the same diameter.

The metal sheet 50 may be positioned between the transfer roller 30 and the counter roller 40 such that the transfer roller 30 and the counter roller 40 contact the metal sheet 50. Thereby, a force may be applied to the metal sheet 50 and the metal sheet 50 may be firmly positioned and held between the transfer roller 30 and the counter roller 40. Also, the metal sheet 50 may be transported by the rotational movement of the transfer roller 30 and/or the counter roller 40.

As indicated in FIG. 2, the pattern roller 20 may rotate in a counterclockwise direction. The transfer roller 30 may rotate in a clockwise direction. The counter roller 40 may rotate in a counterclockwise direction. The metal sheet 50 may travel in a longitudinal direction.

The direction of rotation of the pattern roller 20, the transfer roller 30 and the counter roller may be determined by the travel direction of the metal plate 50. Hence, the pattern roller 20 may also rotate in a clockwise direction, the transfer roller 30 may rotate in a counterclockwise direction and the counter roller 40 may rotate in a clockwise direction. Preferably, the transfer roller 30 and the pattern roller 20 rotate in opposite directions.

Each of the pattern roller 20, the transfer roller 30 and the counter roller 40 may be driven by a (respective) drive (not shown). A controller (not shown) may be configured to control the movement of the pattern roller 20, the transfer roller 30 and the counter roller 40.

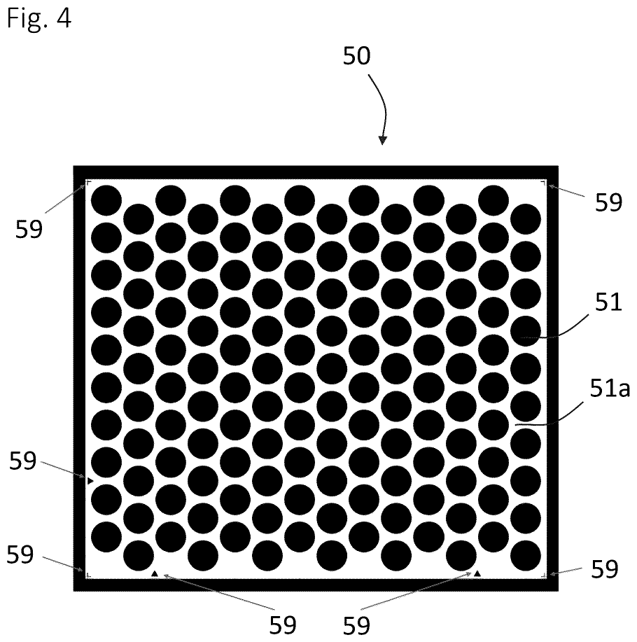

After the coating is applied to the metal sheet 50, the coating may be dried or cured and a coated metal sheet 50 is provided (see FIG. 4). The metal sheet 50 may comprise coated areas 51 and uncoated areas. The coated areas 51 may correspond to the first areas 11 of the pattern roller 20. The metal sheet 50 may also comprise at least one or at most one coated area 51a. The coated area 51a may correspond to the second area 12 of the pattern roller 20. Coating taken up by the second area 12 of the pattern roller 20 may be transferred (via the transfer roller 30) to the metal sheet 50 such that coated area 51a is produced.

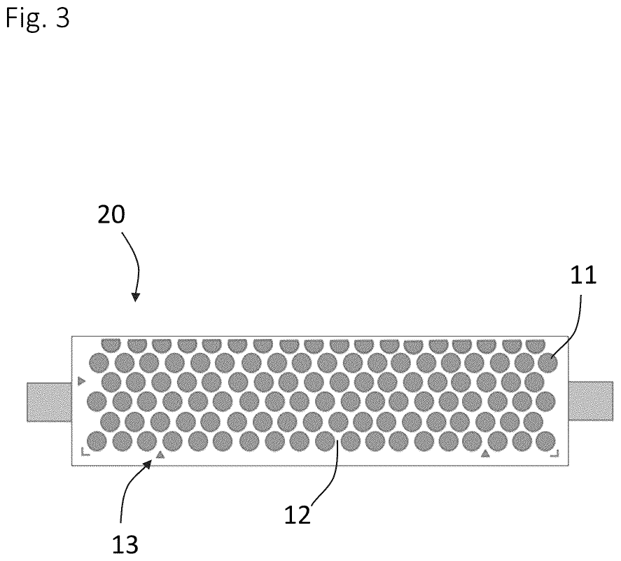

FIG. 3 shows a side view of a pattern roller 20. The pattern roller 20 may comprise a plurality of first areas 11. As mentioned above, each of the first areas 11 may include dimples or cells to take up coating from storage 10.

The pattern roller 20 may comprise at least 5, preferably at least 10, preferably at least 20, preferably at least 30, preferably at least 50, first areas 11. The pattern roller 20 may comprise at least 2, preferably at least 5, preferably at least 10, first areas 11 next to each other in a longitudinal direction of the pattern roller 20. The longitudinal direction of the pattern roller 20 may extend in the rotational axis of the pattern roller 20. First areas 11 next to each other in the longitudinal direction of the pattern roller 20 may be called rows. The pattern roller 20 may comprise at least 2, preferably at least 5, preferably at least 10, rows of first areas 11.

The first areas 11 may all have substantially the same shape, size, geometry, transfer volume and/or transfer weight.

The pattern roller 20 may comprise at least one or at most one second area 12. The second area 12 may surround the first areas 11. First areas 11 of the pattern roller 20 may be separated by the second area 12. The second area 12 may comprise dimples or cells to take up coating from storage 10.

The pattern roller 20 may comprise at least one third area 13. The pattern roller 20 may comprise at least 2, preferably at least 4, preferably at least 6, preferably at least 8, third areas 13. The third areas 13 may be configured to take up or to absorb or to pick up coating from the storage 10. Coating in third areas 13 of the pattern roller 20 may be transferred to the transfer roller 30, and from the transfer roller 30, the coating may be transferred to the metal sheet 50 to form markings 59 on the metal sheet.

Each of the third areas 13 may comprise a plurality of dimples. The third areas 13 may be engraved into the surface of the pattern roller. The third areas 13 may engraved by mechanical engraving or laser engraving.

At least two of the third areas 13 may have a different shape, size, geometry, transfer volume and/or transfer weight.

At least one of the third areas 13 or all of the third areas 13 may have a different shape, size, geometry, transfer volume and/or transfer weight than at least one of the first areas 11.

The third areas 13 may have the shape of a line, an arrowhead or two lines perpendicular to each other. Other shapes of the third areas 13 are possible. For example, the third areas 13 may include at least one letter and/or at least one number.

FIG. 4 shows a coated metal sheet 50. The metal sheet 50 as shown in FIG. 4 may have been coated according to the above-mentioned procedure, i.e., coating from storage 10 was taken up by first areas 11 of the pattern roller 20, the coating in the first areas 11 was transferred to the transfer roller 30, and the coating from the transfer roller 30 was transferred to a metal sheet 50. Also, coating from storage 10 may have been taken up by second area 12 of the pattern roller 20, the coating in the second area 12 was transferred to the transfer roller 30, and the coating from the transfer roller 30 was transferred to a metal sheet 50.

The coated metal sheet 50 may comprise a plurality of coated areas 51 (also called coating 51 herein). The coated areas 51 correspond to the first areas 11 of the pattern roller 20. For example, the number of coated areas 51 on the metal sheet 50 may be substantially equal to the number of first areas 11 of the pattern roller 20. The circumference of the pattern roller 20 may be substantially equal to or longer than the length of the metal sheet 50. Thereby, one full rotation of the pattern roller 20 is sufficient to transfer the desired coating to the metal sheet 50.

The coated metal sheet 50 may comprise at least one uncoated area. The uncoated area may be an area that does not include the coating of the coated areas 51. The uncoated area may surround and/or separate the coated areas 51.

The coated metal sheet 50 may comprise a coated area 51a. The coated area 51a may be at least located between two adjacent first areas 11.

The coated metal sheet 50 may comprise at least one marking 59. The coated metal sheet 50 may comprise at least 2, preferably at least 4, preferably at least 6, preferably at least 8, preferably at least 15, preferably at least 30, markings 59.

The markings 59 may correspond to the third areas 13 of the pattern roller 20.

The markings 59 may allow a user or a machine to verify a correct positioning of the coated areas 51 on the coated metal sheet. The markings 59 may also indicate a direction for further use of the coated metal sheet.

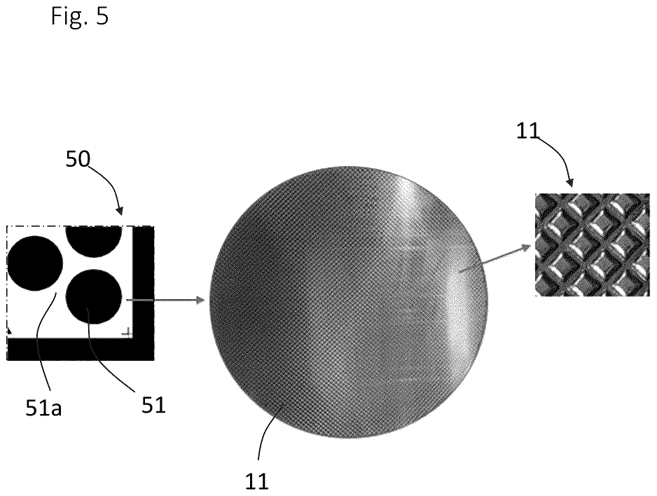

FIG. 5 shows a relation between a coated area 51 on a metal sheet 50 and a first area 11 on the pattern roller 20. On the left side of FIG. 5, a portion of the coated metal sheet 50 is shown. This portion of the coated metal sheet 50 may be the bottom right corner of the coated metal sheet 50 of FIG. 4. In the middle of FIG. 5, a first area 11 of the pattern roller 20 is shown. On the right side of FIG. 5, a portion of the first area 11 is shown in a magnified illustration.

In FIG. 5, the coated area 51 has a circular shape or area. The first area 11 may correspond to the coated area 51. In FIG. 5, the first area 11 also has a circular shape or area and the size of the first area 11 is equal to the size of the coated area 51. This may apply to all first areas 11 and corresponding coated areas 51.

As can be seen on the right side of FIG. 5, the first area 11 comprises a plurality of dimples (or cells of depressions). The dimples may be configured to take up the coating from the storage 10 to transfer the coating to the transfer roller 30.

This similarly applies to the coated area 51a, i.e., the second area 12 of the pattern roller 20 may comprise a plurality of dimples (or cells or depressions) to take up coating from the storage 10. The coating 12 in the second area 12 may be transferred to the metal sheet 50 to produce coated area 51a.

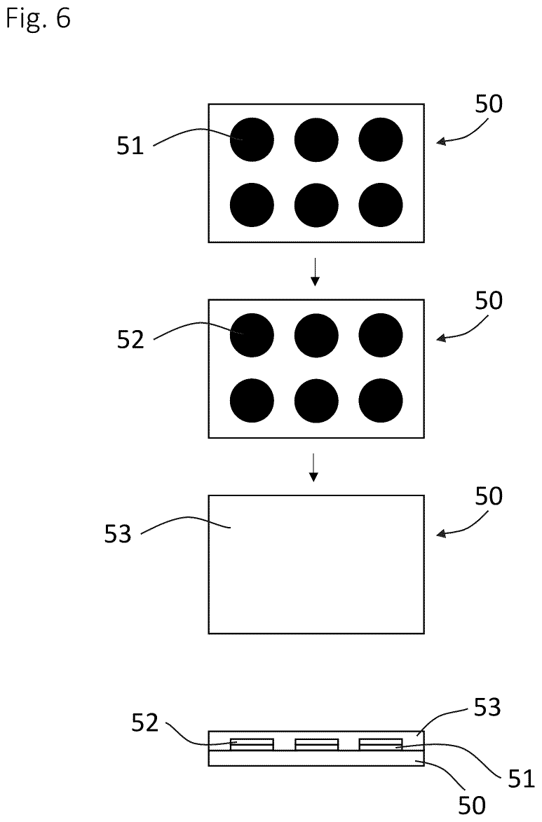

FIG. 6 shows different steps in a method for applying more than one coating to a metal sheet 50. The first illustration shows a metal sheet 50 onto which first coated areas 51 are applied. The first coated areas 51 may be applied by any herein described procedure. The first coated areas 51 may only partially cover the metal sheet 50.

The size of the first coated areas 51 and/or the size of the second coated areas 52 may be smaller than the size of the closure blank cut out from the metal sheet 50. The size may be an area.

The second illustration shows the metal sheet 50 onto which second coated areas 52 are applied. The second coated areas 52 may be applied by any herein described procedure. The second coated areas 52 may only partially cover the metal sheet 50. Preferably, the second coated areas 52 substantially exactly cover the first coated areas 51. Alternatively, the second coated areas 52 may have a different size and/or shape than the first coated areas 51. It is preferred that the second coated areas 52 at least partially or fully cover the first coated areas 51.

The third illustration shows the metal sheet 50 onto which a third coating 53 is applied. The third coating 53 may be applied by any herein described procedure. Preferably, the third coating 53 is applied to the metal sheet 50 by using a roller with a smooth surface. This roller may not include first areas 11 as described herein. The third coating 53 may fully cover the first and second coated areas 51, 52. Specifically, the third coating 53 may cover substantially the entire metal sheet 50.

The order of application of the first coated areas 51, the second coated areas 52 and the third coating may be interchangeable and different from the above-described example. For example, the third coating may be applied to the metal sheet 50 in a first step, then the first coated areas 51 or the second coated areas 52 may be applied to the metal sheet 50. Also, the first or second coated areas 51, 52 may be applied to the metal sheet 50, then the third coating 53 may be applied and finally the remaining coated areas (second coated areas 52 or first coated areas 51) may be applied to the metal sheet 50.

Different rollers may be used for application of the first coated areas 51, the second coated areas 52 and the third coating 53.

The third coating 53 may be in contact with the surface of the metal sheet 50.

The fourth illustration of FIG. 6 shows a schematic cross-section view of the metal sheet 50. The first coated areas 51 may (only) partially cover the metal sheet 50. The second coated areas 52 may (only) partially cover the metal sheet 50. The third coating 53 may fully cover the metal sheet 50.

When portions of the metal sheet 50 are cut out to produce a closure blank, the cut out may have a diameter that is larger than the diameter of the first and second coated areas 51, 52. Thereby, the cutting edge does not cross the first and second coated areas 51, 52.

FIG. 7a shows a closure blank 55. The closure blank 55 was cut out (or stamped out) from the metal sheet 50. Preferably, the closure blank 55 was cut out from any one of the herein disclosed coated metal sheets 50.

The closure blank 55 may comprise a first area 56 and a second area 57. The first area 56 may be located in a center region of the closure blank 55. The second area 57 may (fully) surround the first area 56.

Coating may (only) be present in the first area 56. The second area 57 may not be coated with the coating in the first area 56. Alternatively, the second area 57 may be coated with the coating in the first area 56, preferably with a lower amount. The size and shape of the first area 56 of the closure blank 55 may correspond to the size and shape of a first area 11 of the pattern roller 20. The first area 56 of the closure blank 55 may be coated by coating from a first area 11 of the pattern roller 20. The second area 57 of the closure blank 55 may correspond to the second area 12 of the pattern roller 20.

The second area 57 of the closure blank 55 may correspond to an area of the closure manufactured from the closure blank 55 that does not come into contact with a filling of a bottle or jar that is closed by the closure.

The diameter of the coated first area 56 of the closure blank 55 may be at most 95%, preferably at most 90%, preferably at most 85%, preferably at most 80%, preferably at most 75%, preferably at most 70%, preferably at most 65%, preferably at most 60%, preferably at most 55%, preferably at most 55%, of the outer diameter of the closure blank 55.

The diameter of the coated first area 56 of the closure blank 55 may be at least 50%, preferably at least 55%, preferably at least 60%, preferably at least 65%, preferably at least 70%, preferably at least 75%, preferably at least 80%, preferably at least 85%, preferably at least 90%, preferably at least 95%, of the outer diameter of the closure blank 55.

The diameter of the coated first area 56 of the closure blank 55 may be between 50% and 95%, preferably between 50% and 90%, preferably between 60% and 80%, preferably between 65% and 75%, of the outer diameter of the closure blank 55.

FIG. 7b shows a closure 200. The closure 200 may be formed from a closure blank, for example, from the closure blank 55 of FIG. 7a. This can be done by using techniques known in the art. While the closure 200 shown in FIG. 7b is a lug closure, other closure types are possible, for example, a press-on twist-off closure.

The closure 200 may comprise a metal support 210. The metal support 210 may be formed from the metal sheet 50.

The closure 200 may comprise a skirt portion 220 and a top portion 230. The skirt portion 220 may be a portion that interacts with a threaded portion of a bottle or jar when the closure 200 closes the bottle or jar. The top portion 230 may cover an opening of the bottle or jar when the closure 200 closes the bottle or jar.

A sealing element (not shown) may be provided in the closure 200. The sealing element may contact (only) the top portion 230 of the closure 200. Alternatively, the sealing element may contact the top portion 230 and the skirt portion 220.

The top portion 230 of the closure 200 may correspond to the first area 56 of the closure blank 55. The skirt portion 220 of the closure 200 may correspond to the second area 57 of the closure blank 55.

The top portion 230 of the closure 200 may be fully covered with the coating. The skirt portion 220 of the closure 200 may only be partially covered with the coating or may not be covered with the coating.

The skirt portion 230 of the closure 200 will typically not come into contact with the filling of the bottle or jar. At least a portion of the top portion 230 of the closure 200 will typically not come into contact with the filling of the bottle or jar.

Each of the first areas 11 of the pattern roller 20 may have a diameter of at least 50%, preferably of at least 55%, preferably of at least 60%, preferably of at least 65%, preferably of at least 70%, preferably of at least 75%, preferably of at least 80%, preferably of at least 85%, preferably of at least 90%, preferably of at least 95%, preferably of at least 100%, preferably of at least 10 %, preferably of at least 110%, preferably of at least 120%, of the outer diameter of the closure 200.

Each of the first areas 11 of the pattern roller 20 may have a diameter of at most 120%, preferably of at most 115%, preferably of at most 110%, preferably of at most 105%, preferably of at most 100%, preferably of at most 95%, preferably of at most 90%, preferably of at most 85%, preferably of at most 80%, preferably of at most 75%, preferably of at most 70%, preferably of at most 65%, preferably of at most 60%, preferably of at most 55%, preferably of at most 50%, of the outer diameter of the closure 200.

Each of the first areas 11 of the pattern roller 20 may have a diameter of between 60% and 120%, preferably between 65% and 115%, preferably between 70% and 110%, preferably between 75% and 110%, preferably between 80% and 110%, preferably between 85% and 110%, preferably between 90% and 110%, preferably between 95% and 100%, of the outer diameter of the closure 200.

1. A machine (100) for manufacturing closures (200), the machine (100) comprising:
a conveyor device (60) configured to provide a metal sheet (50);
at least one storage (10) storing a coating;
at least one pattern roller (20), wherein the pattern roller (20) comprises a plurality of first areas (11) and at least one second area (12), wherein the first areas (11) are configured to take up the coating from the storage (10); and
at least one transfer roller (30),
wherein the pattern roller (20) is configured to transfer the coating in the first areas (11) to the transfer roller (30) and the transfer roller (30) is configured to transfer the coating to the metal sheet (50) such that the metal sheet (50) is provided with the coating in areas (51) corresponding to the first areas (11) of the pattern roller (20).

2. The machine of claim 1, wherein each of the first areas (11) of the pattern roller (20) comprises a plurality of dimples and/or wherein the surface of the second area (12) of the pattern roller (20) is smooth.

3. The machine of claim 1, wherein the second area (12) is configured to take up the coating from the storage (10), wherein the pattern roller (20) is configured to transfer the coating in the first areas (11) and in the second area (12) to the transfer roller (30), and wherein the transfer roller (30) is configured to transfer the coating to the metal sheet (50) such that the metal sheet (50) is provided with the coating in areas (51, 51a) corresponding to the first areas (11) and the second area (12) of the pattern roller (20).

4. The machine of claim 3, wherein the second area (12) comprises a plurality of dimples, preferably wherein the transfer volume and/or transfer weight of the second area (12) is smaller than of the first areas (11).

5. The machine of claim 1, wherein each of the first areas (11) of the pattern roller (20) has a substantially circular shape or area and/or wherein the second area (12) of the pattern roller (20) surrounds the first areas (11) of the pattern roller (20).

6. The machine of claim 1, wherein each of the first areas (11) of the pattern roller (20) has a diameter between 10 mm and 250 mm, preferably between 35 mm and 135 mm.

7. The machine of claim 1, wherein the machine (100) is configured to apply at least two layers of coating (51, 52, 53) to the metal sheet (50), preferably wherein the layers of coating (51, 52, 53) overlap each other, preferably wherein at least one of the layers of coating (51, 52, 53) covers substantially the entire metal sheet (50) and/or at least one of the layers of coating (51, 52, 53) only partially covers the metal sheet (50).

8. The machine of claim 1, wherein each of the first areas (11) comprises a first subarea and a second subarea, wherein the first subarea is configured to take up a different amount of coating per area than the second subarea per area.

9. The machine of claim 1, further comprising a counter roller (40), wherein the metal sheet (50) is positioned between the transfer roller (30) and the counter roller (40) when the coating is transferred from the transfer roller (30) to the metal sheet (50).

10. The machine of claim 1, wherein the transfer roller (30), preferably the surface of the transfer roller (30), comprises a plastic, in particular an elastomer.

11. The machine of claim 1, wherein the pattern roller (20) comprises at least one third area (13), wherein the third area (13) is configured to transfer at least one marking (59) to the metal sheet (50) for verification of a correct positioning of the coating areas (51) on the metal sheet (50).

12. A method for manufacturing closures (200), the method comprising the steps of:
Providing a metal sheet (50);
Transferring a coating from a plurality of first areas (11) of a pattern roller (20) to a transfer roller (30);
Transferring the coating from the transfer roller (30) to the metal sheet (50) such that the metal sheet (50) is provided with the coating in areas (51) corresponding to the first areas (11) of the pattern roller (20).

13. A closure (200), the closure (200) comprising:
a metal support (210); and
at least one coating (51, 52),
wherein the coating (51, 52) does not cover the entire metal support (210).

14. The closure of claim 13, wherein the closure (200) comprises at least two different coatings (51, 52, 53), wherein one of the coatings (51, 52, 53) is the coating (51, 52) that does not cover the entire metal support (210) and the other one of the coatings (53) covers the entire metal support (210).

15. A pattern roller (20) for transferring coating to a transfer roller (30), the pattern roller (20) comprising:
a plurality of first areas (11), wherein the first areas (11) are configured to take up the coating from a storage (10); and
at least one second area (12), wherein the second area (12) is configured to take up the coating from the storage (10),
wherein the transfer volume and/or transfer weight per unit surface area of the second area (12) is smaller than of the first areas (11).
